(19) United States
(12) Patent Application Publication
(10) Pub. No.: US 2020/0157415 A1
(43) Pub. Date: May 21, 2020

(54) PROPPANT TREATMENT AND ENHANCED WATER IMBIBITION IN TIGHT SUBTERRANEAN FORMATIONS BY USING DENDRIMERS

(71) Applicant: TRICAN WELL SERVICE LTD., Calgary (CA)

(72) Inventors: Harvey QUINTERO, Calgary (CA); Chuanzhong WANG, Calgary (CA); Kewei ZHANG, Calgary (CA); Bill O'NEIL, Calgary (CA); Robert HAWKES, Calgary (CA)

(21) Appl. No.: 16/615,365

(22) PCT Filed: May 31, 2018
(86) PCT No.: PCT/CA2018/050645

§ 371 Date: Nov. 20, 2019

Related U.S. Application Data
(60) Provisional application No. 62/513,551, filed on Jun. 1, 2017.

(51) Int. Cl. C09K 8/80; C09K 8/88; C09K 8/60

(52) U.S. Cl. CPC C09K 8/805; C09K 8/602; C09K 8/88

(57) ABSTRACT

The present disclosure is directed to the use of dendrimers in various compositions and methods applicable in oilfield applications, such as, but not limited to, in compositions containing oilfield chemical additives for enhancing the efficacy of the oilfield chemical additives in such compositions and in compositions containing an aqueous liquid to allow the compositions to exhibit an enhanced water imbibition in a subterranean hydrocarbon-bearing formation.

### CROSS REFERENCE TO RELATED APPLICATIONS

The present application claims priority to U.S. Provisional Patent Application Ser. No. 62/513,551 filed on Jun. 1, 2017, the entire contents of which is hereby expressly incorporated herein by reference.

### FIELD

The present disclosure generally relates to the use of dendrimers in various oilfield applications, including, but not limited to: compositions and methods for hydraulic fracturing operations, more particularly, the use of dendrimers to treat proppants for making aqueous slurries during or prior to a fracturing operation; compositions and methods for water imbibition enhancement, more particularly, the use of dendrimers to lower in-situ interfacial tension between hydrocarbons and aqueous fluids to enable the composition to imbibe deeper in subterranean formations to increase hydrocarbon recovery, especially in tight oil and gas formations, such as shale formations; and, compositions and methods for treating particulates, including sands, to reduce dust during various applications, such as hydraulic fracturing.

### BACKGROUND

Hydraulic fracturing is a technology commonly used to enhance oil and gas production from a subterranean formation. Combined with horizontal drilling, it has revolutionised the development of unconventional reservoirs, such as shale formations, which have very low permeability in the nano-Darcy range. During a hydraulic fracturing operation, a large amount of fracturing fluid is injected along a wellbore into a subterranean formation at a pressure sufficient to initiate fractures in the formation. Following fracture initiation, particulates, commonly known as proppants, are suspended in a fracturing fluid and transported into the fractures as a slurry. At the last stage, the fracturing fluid is flowed back to the surface leaving proppant in the fractures that form proppant packs which prevent the fractures from closing after pressure is released. The proppant packs provide highly conductive channels through which hydrocarbons can effectively flow.

There are a number of different known proppants available for use, including sands, ceramic particulates, bauxite particulates, glass spheres, resin coated sands, synthetic particulates and the like. Because of its readily availability and low cost, sand is by far the most commonly used proppant. Proppants normally range in size from between about 10 to about 100 U.S. mesh, which is about 2,000 to about 150 μm in diameter. More recently, micro-proppants, which are in the size range of 100 to 300 U.S. mesh, have also been used with shale formations.

A vast majority of fracturing fluids currently used are aqueous-based because of their low cost and high versatility. Since proppants normally have a significantly higher density than water (for example, the density of sand is typically about 2.6 g/cm³ while that of water is 1 g/cm³), a high viscosity fluid is required to prevent the proppants from settling out of the slurry. Therefore, to effectively transport proppants, a sufficient amount of water-soluble viscosifiers like polymers (i.e., linear or cross-linked polymers) or viscoelastic surfactants are commonly added to the fracturing fluid to form a gel. The physical entanglement of polymer chains forms a gel significantly increasing the fluid viscosity/viscoelasticity, and thus its suspension capability. For example, a water-soluble polymer, such as guar gum or its derivatives, may be added to the aqueous liquid.

To further enhance fluid viscosity, it is common to chemically cross-link polymer chains with certain chemical compounds, known as cross-linkers, forming a cross-linked gel. Guar gum cross-linked by borates is an example of this technology.

In comparison with a fluid having a cross-linked gel, fluids comprising linear gels (i.e., fluids containing enough polymer to significantly increase fluid viscosity without cross-linking) cause less formation damage and are more cost-effective, but they have relatively poor suspension capability. Viscoelastic surfactants cause less damage, but are much more expensive.

Slick water or simply water fracturing is a method of fracturing using water containing very small amounts of a friction reducing agent (usually in the range from about 0.015% to 0.06% of the fluid), and is widely used as a fracturing fluid, especially for fracturing shale or tight formations because it can generate long and thin fracture networks and low cost. Pumping rates must be sufficiently high to transport proppant over long distances before entering the fracture. The fracturing fluid is pumped down the well-bore as fast as 100 bpm, as compared to conventional (non-slick water) fracturing where the top speed of pumping is around 60 bpm. A friction-reducing agent is added in water to suppress turbulence at high pumping rates, thus reducing pumping pressure. Polyacrylamide-based friction reducing agents, which include polyacrylamides and polyacrylamide copolymers (which contain other monomers in addition to acrylamide monomers), are predominantly used in an amount between about 0.015 wt. % to about 0.06 wt. % of the fluid. Because of its low cost and its ability to create a complex fracture network leading to better production, slick water has recently become the “go-to” fluid for fracturing shale or tight formations.

When fracturing conventional formations, such as sandstone formations, it is normally beneficial to flow the fracturing fluid out of the wellbore as soon as possible after completing the treatment. However, the concept of soakback, where the well is left shut in for several months after the fracturing operation to allow water to soak in/imbibe deep into the formation, has been proposed recently as the new best practice for flowback after fracturing formations because it has been shown to result in improved production and reduced water disposal cost. Conventional surfactants, such as non-ionic surfactants including ethoxylated fatty alcohols, and anionic surfactants, including alkyl sulfates and alkyl aryl sulfonates have been used to enhance water imbibition into shale formations with mixed results.

After the well is put into production, crude oil and/or gas flows out of the well, often not as a single phase, but as a multi-phase flow, namely as a mixture of oil or gas and water. Further, crude oil itself is a complex mixture of different hydrocarbons ranging normally from butane to long chain paraffin wax, as well as asphaltene, while water is normally brine water comprising different amounts of inorganic ions including K⁺, Ca²⁺, Mg²⁺, Cl⁻, CO₃²⁻ and SO₄²⁻. During production, because of changes in temperature, pressure and other conditions, wax and asphaltene can precipitate out of oil forming organic scales and carbonate salts, such as CaCO₃ or MgCO₃, or sulphate salts, such as CaSO₄ or MgSO₄, can precipitate out of water forming inorganic scales. The formation of scale, be it organic or inorganic, often occurs in both the subterranean formation and in the wellbore and impedes production flow and worsens pipe corrosion. In addition, other problems, such as the formation of hydrogen sulfide and emulsions, also often occur in the life cycle of a production well.

To mitigate scale formation, it is common to add chemical inhibitors known as scale inhibitors directly into the fracturing fluid during fracturing operations. Unfortunately, most of these chemical inhibitors flowback together with the fracturing fluid after the fracturing treatment, significantly compromising their intended applications.

To prolong the effectiveness of these types of additives, a few technologies have been developed. For example, the additives have been impregnated into pores of specially engineered ceramic proppants, as described in U.S. Pat. No. 5,964,291 (hereafter the '291 patent), or adsorbents have been used to adsorb the additives onto naturally occurring diatomaceous earth, such as clays, which are then added into hydraulic fracturing fluid as described in U.S. Pat. No. 7,493,955 (hereafter the '955 patent). One of the potential drawbacks of the '291 patent teaching is that ceramic proppants are very expensive compared to sand proppants, and they only find limited applications in formations deeper than 4,000 meters which excludes current shale formations. The teaching of the '955 patent provides a versatile method for adsorbing different additives and releasing them slowly into formations to prolong their effectiveness. Its drawback is that adding extra small particles, such as clay, into the formation may reduce conductivity of the proppant pack which is vital for well production.

Thus, there is a need for the development of more efficient and cost-effective technology for the controlled release of chemical additives in a hydrocarbon-bearing formation. As well, there is a need to have a substance that is capable of enhancing efficiently the water imbibition in shale formations during or after a fracturing operation.

### SUMMARY

Embodiments herein generally provide compositions containing a dendrimer for use in various oilfield applications and methods for retaining oilfield chemical additives in a fluid, such as a hydraulic fracturing fluid, for example by coating a particulate with a dendrimer and/or hydrophobically-modified dendrimer and an oilfield chemical additive.

According to one aspect, provided are methods for coating particulates with a dendrimer and/or hydrophobically-modified dendrimer, and an oilfield chemical additive, mixing the coated particulate with a hydraulic fracturing fluid, preferably a water-based fracturing fluid, and more preferably a slick water fracturing fluid, and pumping the mixture into a formation, whereafter the oilfield chemical additive is slowly leached out of the coated particulates and into the hydraulic fracturing fluid ensuring long lasting effects in the formation.

In another broad aspect, described herein is a method of preparing an aqueous proppant slurry composition comprising:
a) contacting particulates with a liquid medium containing a dendrimer and/or a hydrophobically-modified dendrimer, and an oilfield chemical additive;
b) separating the liquid medium from the coated particulates to form treated proppants; and
c) adding the treated proppants into a fracturing fluid in a hydraulic fracturing operation.

In another broad aspect, described herein is a method of preparing an aqueous proppant slurry composition comprising:
a) contacting particulates with a liquid medium containing a dendrimer and/or a hydrophobically-modified dendrimer,
b) separating the liquid medium from the coated particulates to form pre-treated proppants; and
c) contacting the pre-treated proppants, preferably by spraying, with an oilfield chemical additive to form proppants before the proppants are added into the fracturing fluid during fracturing operations.

In another aspect, described herein is a method of hydraulic fracturing of a formation comprising:

a) preparing a hydraulic fracturing fluid by mixing proppants with an aqueous liquid:
wherein the proppants are obtained by coating particulates with:
i) a dendrimer and/or hydrophobically-modified dendrimer; and
ii) an oilfield chemical additive selected from the group consisting of: a scale inhibitor, a biocide, and an H₂S scavenger; and

b) pumping the hydraulic fracturing fluid into the formation.

In another aspect, described herein is a method of controlling the release of an oilfield chemical additive into an aqueous fluid, said method comprising coating particulates with a dendrimer and/or hydrophobically-modified dendrimer and the oilfield chemical additive, wherein the coating of the particulate with the dendrimer and/or hydrophobically-modified dendrimer delays or prolongs the release of the oilfield chemical additive from the surface of the particulate as compared to a particulate that is not coated with the dendrimer and/or hydrophobically-modified dendrimer, when the particulate is suspended in the aqueous fluid.

In another aspect, described herein is a method of controlling the release of an oilfield chemical additive into an aqueous fluid, said method comprising mixing a dendrimer and/or hydrophobically-modified dendrimer with the oilfield chemical additive, then adding the mixture into an aqueous fluid, such as fracturing fluid, wherein the dendrimer and/or hydrophobically-modified dendrimer delays or prolongs the release of the chemical additive from the surface of the particulate as compared to directly adding the oilfield chemical additive in the fluid.

In another aspect, described herein is the use of a hydrophobically-modified dendrimer to increase oil recovery in enhanced oil recovery (EOR) processes by adding the hydrophobically-modified dendrimer to an aqueous fluid that is pumped into oil reservoir in the injection well and recovering the oil and part of injected aqueous liquid in another well, such as a production well.

In another aspect, described herein are compositions and methods for reducing fugitive dust from particulates comprising coating the particulates with a dendrimer and/or hydrophobically-modified dendrimer thereby reducing dust production therefrom as compared to uncoated particulates. A liquid, preferably an aqueous liquid or alcohol or a mixture of alcohol and water, containing the dendrimer and/or hydrophobically-modified dendrimer is applied, preferably by spraying, to the particulates. The particulates may then be transported or mixed with a fracturing fluid in a fracturing operation.

In another aspect, described herein are methods for reducing fugitive dust comprising spraying a composition containing a dendrimer and/or a hydrophobically-modified dendrimer onto a road or field worksite. In one aspect, the composition comprises a liquid, preferably an aqueous liquid or alcohol or a mixture of alcohol and water, and the dendrimer and/or hydrophobically-modified dendrimer.

In another aspect, described herein is the use of a hydrophobically-modified dendrimer to increase water imbibition by adding the hydrophobically-modified dendrimer to an aqueous fracturing fluid, preferably a slick water fracturing fluid, during or after a fracturing operation in shale formations.

In another aspect, described herein is the use of a hydrophobically-modified dendrimer in combination with a conventional surfactant, including non-ionic, anionic, cationic and amphoteric surfactants, to increase water imbibition by adding a mixture of the hydrophobically-modified dendrimer and the conventional surfactant to an aqueous fracturing fluid, preferably a slick water fracturing fluid, during or after a fracturing operation in shale formations. In another aspect, described herein is the use of a hydrophobically-modified dendrimer or a hydrophobically-modified dendrimer in combination with a conventional surfactant, including non-ionic, anionic, cationic and amphoteric surfactants, to increase oil recovery in enhanced oil recovery (EOR) processes, by adding a hydrophobically-modified dendrimer or the mixture of the hydrophobically-modified dendrimer and conventional surfactant to an aqueous fluid, pumping the mixture into an oil reservoir in the injection well and recovering the oil and part of injected aqueous liquid in another well, such as a production well.

In another aspect, described herein is an aqueous hydraulic fracturing fluid, preferably a slick water fracturing fluid, comprising a dendrimer and/or hydrophobically-modified dendrimer.

In yet another aspect, described herein is a method of hydraulically fracturing a formation, comprising:

a) preparing a hydraulic fracturing fluid by mixing a dendrimer and/or hydrophobically-modified dendrimer with a fluid, and

b) pumping the hydraulic fracturing fluid into the formation.

### BRIEF DESCRIPTION OF THE FIGURES

FIG. 1 depicts the release of an oilfield chemical additive coated on a proppant with and without a dendrimer according to the present disclosure.

### DETAILED DESCRIPTION

The present disclosure is generally directed to dendrimers and their use in various applications, preferably oilfield applications. It has been surprisingly found that the dendrimers of the present disclosure can be useful in compositions containing oilfield chemical additives to enhance the efficacy of the oilfield chemical additives in such compositions. It has also been surprisingly found that the dendrimers of the present disclosure can be useful in compositions containing an aqueous liquid to allow the compositions to exhibit an enhanced water imbibition in a subterranean hydrocarbon-bearing formation. By “enhance” or “enhanced” it is to be understood that the compositions comprising the dendrimers of the present disclosure can increase the performance of the oilfield chemical additives in compositions (for example, a higher activity for a given application rate, a lower application rate with a given effect, and better uptake of the additives) and can allow aqueous liquids to penetrate (imbibe) faster and deeper as compared to compositions that do not contain the dendrimers of the present disclosure.

For the purposes of understanding the specification and the claims appended hereto, a few terms are defined below. Unless defined otherwise, all technical and scientific terms used herein have the same meaning as commonly understood by one of ordinary skill in the art to which embodiments of the disclosure pertain.

The terms “a,” “an,” “the,” “at least one” and “one or more” are used interchangeably. Thus, for example, reference to a composition containing “a compound” may include a composition having one, two, or more compounds.

The term “about” as used herein can allow for a degree of variability in a value or range, for example, it may be within 10%, within 5%, or within 1% of a stated value or of a stated limit of a range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

In the methods and processes described herein, the steps may be carried out in any order, except when a temporal or operational sequence is explicitly recited. Furthermore, specified steps may be carried out concurrently unless explicit claim language recites that they be carried out separately.

The term “comprising” and derivatives thereof are not intended to exclude the presence of any additional component, step or procedure, whether or not the same is disclosed herein. In order to avoid any doubt, all compositions described herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The terms “and/or” or “or”, unless stated otherwise, refer to the listed members individually as well as in any combination.

The term “substantially free” refers to a composition or mixture in which a particular compound is present in an amount that has no material effect on the composition or mixture. For example, “substantially free of a viscosifier” means that a viscosifier may be included in the composition or mixture in an amount that does not materially affect the viscosity of the composition or mixture. It is within the ability of one skilled in the art with the benefit of this disclosure to determine if and whether an amount of a compound has a material effect on the composition. In some embodiments, substantially free may be less than 2 wt. %, less than 1 wt. %, less than 0.5 wt. %, or less than 0.1 wt. % or less than 0.05 wt. % or even less than 0.01 wt. %, based on the total weight of the composition or that no amount of that particular compound is present in the respective composition.

The term “fracturing” or “fracturing operation” refers to a process and method of breaking down a geological formation, in one embodiment a rock formation around a well bore, by pumping fluid at very high pressures in order to increase production rates from a hydrocarbon reservoir. The fracturing processes and methods disclosed herein use otherwise conventional techniques known in the art.

The term “slick water fracturing” refers to a process and method of fracturing in which a low viscosity fluid, in some embodiments having a viscosity of less than about 3 centipoise at 100 sec⁻¹ at ambient temperature, is injected into a formation at a flow rate, in some embodiments between about 60 bpm and about 100 bpm, to generate narrow fractures with low concentrations of proppant.

The term “fracturing fluid” refers to a fluid or slurry used in a formation during a fracturing operation. The fracturing fluids encompassed herein can include fluids comprising aqueous or non-aqueous liquids. Aqueous fracturing fluids are preferred, with slick water fracturing fluids being particularly preferred. There are several different types of fracturing fluids known to those of skill in the art, including, but are not limited to, viscosified water-based fracturing fluids, non-viscosified water-based fracturing fluids, acid-based fracturing fluids and aqueous foam fracturing fluids.

Viscosified water-based fracturing fluids may include linear gel fluids which contain a gelling agent such as, but not limited to, guar, hydroxypropyl guar (HPG), carboxymethyl hydroxypropyl guar (CMHPG), or xanthan, and in some embodiments, may have a viscosity of about 10 centipoise at 100 sec⁻¹ to about 30 centipoise at 100 sec⁻¹ at ambient temperature, and crosslinked gel fluids which contain the gelling agents used in linear gel fluids plus a crosslinker, such as, but not limited to, boron (B), zirconium (Zr), titanium (Ti) or aluminum (Al). Cross-linked fluids can have a higher viscosity of, in some embodiments, about 100 centipoise at 100 sec⁻¹ to about 1000 centipoise at 100 sec⁻¹ at ambient temperature. Linear gel fluids commonly include medium-size proppant, such as, but not limited to, 30/50 size proppant, whereas crosslinked gel fluids commonly include large-size proppant, such as, but not limited to, 20/40 size proppant.

A “slick water fracturing fluid” is a non-viscosified water-based fracturing fluid. These fluids are characterized in having a low viscosity, in some embodiments less than about 3 centipoise at 100 sec⁻¹ at ambient temperature, in other embodiments between about 2 centipoise at 100 sec⁻¹ and 3 centipoise at 100 sec⁻¹ at ambient temperature, and a friction-reducing agent in an amount that reduces friction pressure, in some embodiments between about 50% and about 80% reduced pressure, in other embodiments between about 60% and about 70% reduced pressure, as compared to water that does not have these agents. Common chemistries for friction reduction include, but are not limited to, polyacrylamide derivatives and copolymers added to the fracturing fluid at low concentrations, in some embodiments between about 0.02 wt. % to about 0.05 wt. %, based on the total weight of the fluid. Accordingly, slick water fracturing fluids, in some embodiments, are commonly substantially free of viscosifiers, such as, but not limited to, natural or synthetic polymers and viscoelastic surfactants.

The term “aqueous liquid” as used herein means water, solutions containing water, salt solutions, or water containing an alcohol or other organic solvent. The term “liquid medium” as used herein includes both aqueous and non-aqueous liquids. “Water” as used herein includes, but is not limited to, freshwater, pond water, sea water, salt water or brine source, brackish water and recycled or re-use water, for example, water recycled from previous or concurrent oil- and gas-field operations.

“Oil” as used herein refers to a neutral, nonpolar chemical substance that is hydrophobic (immiscible with water) and lipophilic (miscible with other oils). Representative non-limiting examples of oils used herein include hydrocarbon oils such as mineral oil, and silicone oils such as polydimethylsiloxane (PDMS) and plant oils, such as canola oil. An oil may be added to the compositions and used in the methods herein to promote agglomeration of the particulates or proppants.

The term “imbibe” or “imbibition” refers to the displacement of one fluid by another immiscible fluid. The term “water imbibition” refers to the displacement of a reservoir fluid (for e.g., hydrocarbons) in a porous media (for e.g., reservoir rock) by water.

The term “hydrophobic group” refers to a group lacking an affinity for, or failing to adsorb or absorb water. Examples of hydrophobic groups can include, but are not limited to, long-chain alkanes and fatty acids, fluorocarbons, silicones, various steroids (for e.g. cholesterol) and various polymers (for e.g. polystyrene and polyisoprene).

“Dendrimer” as used herein refers to a highly branched, star-shaped macromolecule with a nanometer-scale dimension and may, in some embodiments, have a highly symmetrical structure or asymmetrical structure. Dendrimers can be defined by three components: a central core, an interior dendritic structure (the branches), and an exterior surface with functional surface groups.

Dendrimers useful in the present disclosure can be made by any suitable process and starting materials well known to those skilled in the art. For example, polyaddition, polycondensation and combinations of polyaddition and polycondensation polymerization processes can be used to produce the dendrimers. In one embodiment, the dendrimers can be synthesized by step-wise chemical methods and every time the synthetic process is repeated, larger dendrimers are created. The size of dendrimers may generally be described by a “generation”, for example Generation 1 (G-1), Generation (G-2), Generation 3 (G-3), etc. Thus, the dendrimers of the present disclosure can be of any generation including, but not limited to, Generation 1 (G-1) dendrimers, Generation 2 (G-2) dendrimers, Generation 3 (G-3) dendrimers, Generation 4 (G-4) dendrimers, Generation 5 (G-5) dendrimers, Generation 6 (G-6) dendrimers, Generation 7 (G-7) dendrimers, Generation 8 (G-8) dendrimers, Generation 9 (G-9) dendrimers or Generation 10 (G-10) dendrimers.

The properties that differentiate dendrimers from traditional linear or slightly branched polymers include intrinsic viscosity, solubility, polyvalency and reactivity. Lower generation dendrimers (for e.g., G-1 or G-2 dendrimers) can be thought of as flexible molecules with no appreciable inner region, while medium-sized dendrimers (for e.g., G-3 or G-4 dendrimers) do have internal space that is essentially separate from the outer shell of the dendrimer. Very large dendrimers (for e.g. G-7 dendrimers and greater) can be thought of as being more like solid particles with very dense surfaces due to the structure of their outer shell. Representative non-limiting examples of dendrimers which may be useful in the present disclosure include, but are not limited to, poly(amidoamine) (PAMAM) dendrimers, poly(ethyleneimine) (PEI) dendrimers, poly(propyleneimine) (PPI), polyether dendrimers, polylysine dendrimers and polyester dendrimers.

According to one embodiment, the dendrimer may comprise a poly(amidoamine) dendrimer. Poly(amidoamine) (PAMAM) dendrimers can generally be manufactured via a divergent method starting from ethylenediamine. Outward growth of the poly(amidoamine) (PAMAM) dendrimers can be accomplished by alternating between two reactions: (a) a Michael addition of the amino-terminated surface onto methyl acrylate, resulting in an ester-terminated outer layer, and (b) coupling with ethylene diamine to achieve a new amino-terminated surface, depicted as follows:

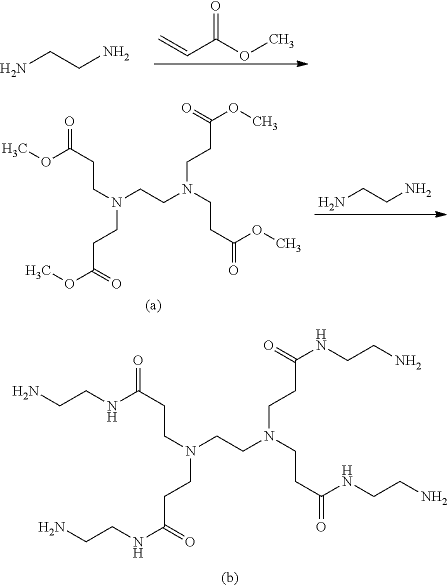

### Generation 1 PAMAM

According to another embodiment, the dendrimer may comprise a poly(ethyleneimine) dendrimer. Poly(ethyleneimine) (PEI) dendrimers can be prepared by a divergent synthetic method from an ethylenediamine core and outward growth can be accomplished via a Michael addition reaction with vinyl bromide followed by conversion of the bromide terminal groups to amine groups using a Gabriel amine synthesis method. More detailed descriptions can be found in: Synthesis and Characterization of Poly(ethyleneimine) Dendrimers (Colloid & Polymer Science: 2008, 289 (6-7), 747-752). An example of a poly(ethyleneimine) dendrimer is a Generation 3 poly(ethyleneimine) dendrimer having a structure according to:

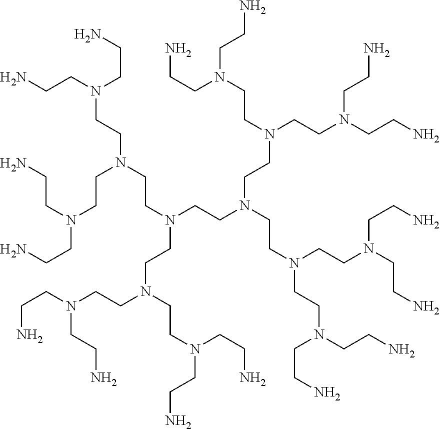 [SMILES: NCCN(CCN)CCN(CCN(CCN)CCN)CCN(CCN(CCN(CCN)CCN)CCN(CCN)CCN)CCN(CCN(CCN(CCN)CCN)CCN(CCN)CCN)CCN(CCN(CCN)CCN)CCN(CCN)CCN]

### Generation 3 PEI

Highly branched poly(ethyleneimine) (PEI) with dendritic structures can be synthesized by the ring opening polymerization of aziridine. Depending on the reaction conditions, different degrees of branching can be achieved. Highly branched poly(ethyleneimines) contain primary, secondary and tertiary amines.

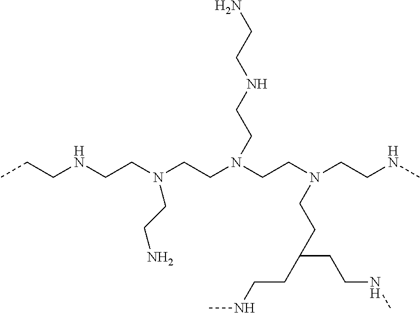

### PEI Obtained from the Polymerization of Aziridine

In still another embodiment, the dendrimer may comprise a poly(propyleneimine) dendrimer. Poly(propyleneimine) (PPI) dendrimers start from a diaminobutane core onto which is added twice the number of amino groups by a double Michael addition of acrylonitrile to the primary amines followed by the hydrogenation of the nitriles. This results in a doubling of the amino groups. The poly(propyleneimine) dendrimer can thus comprise a diaminobutane core with 1, 2, 3, 4 or 5 generations of propyleneimine molecules attached thereto. An example of a poly(propyleneimine) dendrimer is a Generation 3 poly(propyleneimine) having a structure according to:

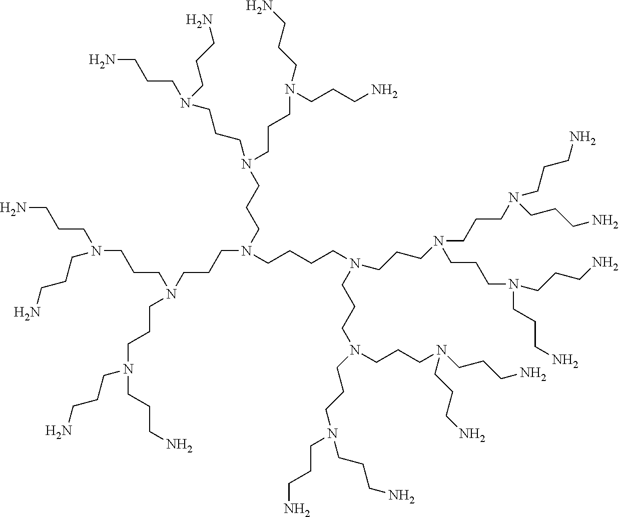 [SMILES: NCCCN(CCCN)CCCN(CCCN(CCCN)CCCN)CCCN(CCCCN(CCCN(CCCN(CCCN)CCCN)CCCN(CCCN)CCCN)CCCN(CCCN(CCCN)CCCN)CCCN(CCCN)CCCN)CCCN(CCCN(CCCN)CCCN)CCCN(CCCN)CCCN]

### Generation 3 PPI

The terminal groups, or surface groups, of dendrimers can be amine, hydroxyl, or carboxyl functional groups. A dendrimer with an amine terminal group is referred to as an amino-terminated dendrimer, those with hydroxyl terminal groups as a hydroxyl-terminated dendrimer, and those with carboxyl terminal groups as a carboxyl-terminated dendrimer. The terminal external groups are hydrophilic, and these groups are connected to hydrophobic moieties on the inside of the dendrimer molecule.

As noted above, the branching structure of dendrimers can be symmetric (i.e. a symmetric dendrimer). In other embodiments, the branching structure of dendrimers can be asymmetric (i.e. an asymmetric dendrimer). An asymmetric dendrimer, sometimes referred to as a hyperbranched polymer, can be synthesized via a one-pot reaction which greatly reduces the complexity and cost of synthesis/production.

The dendrimers useful in the present disclosure, in some embodiments, may be hydrophobically modified (i.e. a hydrophobically-modified dendrimer) by attaching one or more hydrophobic groups on the surface of the dendrimer via covalent chemical bonds. In these embodiments, the hydrophobically-modified dendrimer may be a hydrophobically-modified symmetric dendrimer or a hydrophobically-modified asymmetric dendrimer.

According to one embodiment, the dendrimer may be hydrophobically modified by substitution with one or more aliphatic or aromatic, saturated or unsaturated, linear, branched or cyclic hydrophobic group(s) comprising from 4 carbon atoms to 40 carbon atoms, alternatively from 4 carbon atoms to 20 carbon atoms, alternatively from 6 carbon atoms to 20 carbon atoms, alternatively from 12 carbon atoms to 18 carbon atoms, where each of the carbon atoms can be optionally substituted independently with a hydroxy group, a C₁ to C₁₀ alkyl group, a C₁ to C₁₀ alkoxy group, a phenyl group, a phenyl group substituted with from 1 to 5 groups of a C₁ to C₅ alkyl group or a C₁ to C₅ alkoxy group, a phenoxy group or a phenoxy group substituted with from 1 to 5 groups of a C₁ to C₅ alkyl group or a C₁ to C₅ alkoxy group. In another embodiment, the hydrophobic group(s) may include one or more C₈ to C₃₀ alkyl groups, alternatively C₈ to C₂₂ alkyl groups, an arylalkyl group or an alkylaryl group optionally substituted with a hydroxy group, an alkoxy group or a sulfonate group. In still another embodiment, the hydrophobic group(s) may include one or more C₈ to C₂₂ saturated alkyl groups, alternatively C₈-C₁₆ saturated alkyl groups. In still another embodiment, the hydrophobic group(s) may be derived from natural sources, such as tall oil, tallow oil, soy oil, coconut oil, and palm-oil. In some embodiments, the hydrophobic group(s) may also contain a nitrogen, sulfur or an oxygen atom including, but not limited to, an epoxy, a hydroxy, an ester, a sulfonate or an ether group.

The hydrophobic groups can be attached to the surface of the dendrimer by reacting an amine-terminated or hydroxy-terminated dendrimer with reactants known to those skilled in the art, such as a linear or branched alkyl halide, an alkyl epoxide, a long-chain linear or branched carboxylic acid; a long-chain linear or branched sulfonic acid an alkylketene dimer, a cyclic dicarboxylic anhydride, an alkyl isocyanate or a chloroformic ester of a fatty alcohol, at temperatures ranging from 20° C. to about 150° C. Preferred alkyl halides are primary alkyl chlorides and bromides which, when subjected to conditions favoring bimolecular nucleophilic substitution reactions, provide amines and ethers capped with primary hydrocarbon tails. Preferred alkyl epoxides are those derived from the epoxidation of terminal olefins which, when subjected to ring opening under basic or neutral conditions, provide predominantly amines and ethers capped with primary hydrocarbon tails substituted with hydroxy groups in the β-position. Specific examples of reactants can include, but are not limited to, iso-octyl bromide, cetyl bromide, lauryl bromide, glycidyl phenyl ether, glycidyl iso-propyl ether, glycidyl t-butyl ether, glycidyl 1-naphthyl ether, glycidyl 4-methoxyphenyl ether, glycidyl 2-methylphenyl ether, 1,2-epoxydecane, 1,2-epoxyoctadecane, 4,4-diphenyl-1-butene oxide, 1,11-diphenyl-1-undecene oxide, capric acid, undecanoic acid, lauric acid, tridecanoic acid, myristic acid, pentadecanoic acid, palmitic acid, margaric acid, stearic acid, nonadecanoic acid, arachidic acid, behenic acid, palmitoleic acid, oleic acid, linoleic acid, linolenic acid, arachidonic acid, dodecylbenzenesulfonic acid; tetradecyl chloride, hexadecyl chloride, octadecyl chloride, hexadecenyl oxide, octadecenyl oxide, laurylketene, palm itylketene, stearylketene oleylketene, dodecenylsuccinic anhydride, tetradecylsuccinic anhydride, hexadecenylsuccinic anhydride, tetradecyl isocyanate, hexadecyl isocyanate, octadecyl isocyanate and mixtures thereof.

An example of a hydrophobically-modified dendrimer is dodecylbenzyl sulfonate hydrophobically modified poly(ethyleneimine):

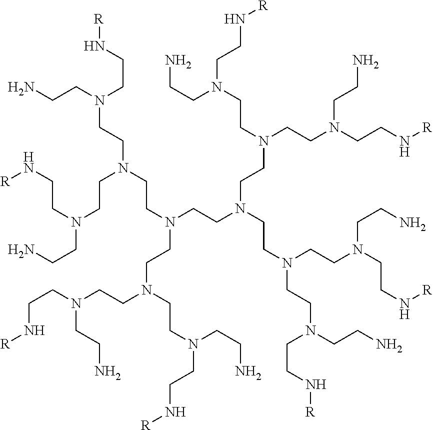

where R═CH₃(CH₂)₁₁C₆H₄SO₂; the S atom is chemically bonded to the N atom and the hydrophobic alkylaryl carbon chain extends outward. The PEI dendritic core can be symmetric or asymmetric of different generations, G-2, G-3 and so on. It has surprisingly been found that the hydrophobically-modified compounds, as compared to the unmodified compounds, can significantly reduce water-oil interfacial intension which is beneficial to increasing water imbibition and therefore oil production in fracturing or EOR operations.

In some embodiments, from about 0.1% to about 99% of the active hydrogens on the surface of the dendrimer are substituted with hydrophobic groups. In other embodiments from about 0.5% to about 90%, alternatively about 1% to about 80%, alternatively about 5% to about 70%, alternatively about 10% to about 60%, alternatively about 15% to about 50%, alternatively about 20% to about 40% or alternatively about 25% to about 35% of the active hydrogens on the surface of the dendrimer are substituted with hydrophobic groups.

In yet another embodiment, at least about 1% of the active hydrogens on the surface of the dendrimer are substituted with hydrophobic groups. In another embodiment, at least about 5%, alternatively at least about 10%, alternatively at least about 20%, alternatively at least about 25%, alternatively at least about 35%, alternatively at least about 50%, alternatively at least about 60%, alternatively at least about 70%, alternatively at least about 80% or alternatively at least about 90% of the active hydrogens on the surface of the dendrimer are substituted with hydrophobic groups.

In still yet another embodiment, less than about 90% of the active io hydrogens on the surface of the dendrimer are substituted with hydrophobic groups. In another embodiment, less than about 80%, alternatively less than about 70%, alternatively less than about 60%, alternatively less than about 50%, alternatively less than about 40%, alternatively less than about 30%, alternatively less than about 20%, alternatively less than about 10% or alternatively at least about 5% of the active hydrogens on the surface of the dendrimer are substituted with hydrophobic groups.

The term “oilfield chemical additive” or “chemical additive” as used herein means any material placed within a well or a hydrocarbon reservoir to address various undesired effects caused by, for example, scale formation, salt formation, paraffin deposition/formation, emulsification (both water-in-oil and oil-in-water), gas hydrate formation, corrosion and asphaltene precipitation, and can include, but is not limited to, a biocide, an inorganic or organic scale inhibitor, a hydrate or halite inhibitor, a corrosion inhibitor, a wax inhibitor, an asphaltene control substance, a demulsifier, a gel breaker, a drag reducer, a salt inhibitor, a gas hydrate inhibitor, an oxygen scavenger, an H₂S scavenger, a chemical scavenger, a foaming agent, a surfactant and a well clean up substance (such as a microorganism, organic molecule, catalyst, acid, ester or aliphatic compounds).

Exemplary inhibitors for preventing inorganic scale formation include, but are not limited to, lignin amines, inorganic and organic polyphosphates, carboxylic acid copolymers, phosphinic polycarboxylate, polyepoxysuccinic acid, polyaspartates, sodium gluconate and sodium glucoheptonate.

Exemplary inhibitors of organic scale formation include but are not limited to, copolymers and homopolymers of ethylene-vinyl acetate, urea, fullerenes (aniline & phenol), particularly copolymers and homopolymers of ethylene-vinyl acetate, alkylaryl sulfonic acid, alkyl phenol, esters of polyacrylate, polymaleate, polyphosphoric acid, polycarboxylic acid, and N,N-dialkylamides of fatty acid.

Exemplary biocides include, but are not limited to, iodopopargyl butyl carbamate, aldehydes, formaldehyde condensates, thazines (e.g., 1,3,5-tris-(2-hydroxyethyl-1,3,5-hexahydrotriazine)), dazomet (e.g., 3,5-dimethyl-2H-1,3,5-thiadiazinane-2-thione), glutaraldehyde (e.g., 1,5 Pentanedial), phenolics, carbonic acid esters, tetrakis(hydroxymethyl)phosphonium sulfate (THPS).

Exemplary H₂S scavengers include, but are not limited to, triazines, aldehydes, metal oxides and chelating agents. amines, carboxamides, alkylcarboxyl-azo compounds cumine-peroxide compounds, morpholino and amino derivatives, morpholine and piperazine derivatives, amine oxides, alkanolamines, and aliphatic and aromatic polyamines.

Exemplary gas hydrate control agents include, but are not limited to, polymers and homopolymers and copolymers of vinyl pyrrolidone, vinyl caprolactam and amine based hydrate inhibitors such as those disclosed in U.S. Patent Application Publication Nos. 2006/0223713 and 2009/0325823, both of which are herein incorporated by reference.

Exemplary wax (paraffin) inhibitors include, but are not limited to, ethylene/vinyl acetate copolymers, urea, fullerenes, acrylates (such as polyacrylate esters and methacrylate esters of fatty alcohols) and olefin/maleic esters.

Exemplary demulsifiers include, but are not limited to, condensation polymers of alkylene oxides and glycols, such as ethylene oxide and propylene oxide condensation polymers of di-propylene glycol as well as trimethylol propane, and alkyl substituted phenol formaldehyde resins, bis-phenyl diepoxides, and esters and diesters of such di-functional products.

Exemplary asphaltene control substances include, but are not limited to, fatty ester homopolymers and copolymers, such as, fatty esters of acrylic and methacrylic acid homopolymers and copolymers, esters of polymaleate, polyphosphoric acid, polycarboxylic acid, and N,N-dialkylam ides of fatty acid, sorbitan monooleate, alkylaryl sulfonic acid, and alkyl phenol.

Exemplary corrosion inhibitors include, but are not limited to, fatty imidazolines, alkyl pyridines, alkyl pyridine quaternaries, fatty amine quaternaries and phosphate salts of fatty imidazolines.

Exemplary foaming agents include, but are not limited to, oxyalkylated sulfates or ethoxylated alcohol sulfates or mixtures thereof,

Exemplary microorganisms include, but are not limited to, anaerobic microorganisms, aerobic microorganisms, and combinations thereof.

Exemplary catalysts include fluid catalytic cracking catalysts, hydroprocessing catalysts, and combinations thereof.

Because they have both hydrophobic and hydrophilic moieties, dendrimers can interact with oilfield chemical additives in different ways via a hydrophobic or hydrophilic interaction. Further they may interact with the oilfield chemical additives via covalent or non-covalent interactions. A non-covalent hydrophobic interaction can be the simple encapsulation of the oilfield chemical additive inside the dendrimers, which may, for example, enhance the solubility of lipophilic additives in water. A non-covalent hydrophilic interaction is an electrostatic interaction between the surface groups of the dendrimer and a charged additive. An example of covalent bonding is the reaction between amino (—NH₂) and hydroxyl (—OH) under certain conditions. Applicant believes that the interaction of the dendrimer with the oilfield chemical additive can retain the chemical additive in the fracturing fluid for a longer period of time than if the fracturing fluid did not comprise a dendrimer. Thus, the dendrimer can provide extended or sustained release of an oilfield chemical additive in an environment of use, for example, in a subterranean crude oil, gas well, water well, or any subterranean formation, as compared to those instances in which the dendrimer is not present. Controlled release of such oilfield chemical additives over an extended period of time can decrease or eliminate the need to retreat wells or subterranean formations (for e.g., hydrocarbon reservoirs) with such additives, providing cost and labor savings as well as less environmental risks. Thus, according to one embodiment a method is provided for controlling the release of an oilfield chemical additive in a subterranean formation by contacting the oilfield chemical additive with the dendrimer either prior to placing the oilfield chemical additive in the subterranean formation or after the oilfield chemical has been placed within the subterranean formation.

Applicant contemplates several embodiments of compositions and methods for making and using the dendrimer alone, or with an oilfield chemical additive, in compositions useful in various oilfield applications, including, but not limited to, a fracturing fluid used in a fracturing operation to recover crude oil from a formation.

Thus, according to one embodiment an imbibition composition for increasing recovery of crude oil from a subterranean hydrocarbon-bearing formation is provided. The imbibition composition comprises a fracturing fluid and a hydrophobically-modified dendrimer. In one embodiment, the fracturing fluid is an aqueous liquid, and in another embodiment, the aqueous liquid is a slick water fracturing fluid.

In still another embodiment the hydrophobically-modified dendrimer comprises a hydrophobically-modified asymmetric dendrimer. In still another embodiment the hydrophobically-modified asymmetric dendrimer comprises at least one hydrophobically-modified asymmetric poly(aminoamide), hydrophobically-modified asymmetric poly(ethyleneimine), hydrophobically-modified asymmetric poly(propyleneimine) or a mixture thereof.

According to some embodiments the imbibition composition may further comprise a surfactant. The surfactant can include an anionic surfactant, a nonionic surfactant, a zwitterionic surfactant, an amphoteric surfactant, a cationic surfactant or a mixture thereof. Anionic surfactants can include, but are not limited to, internal olefin sulfonates, alkoxylated alcohol sulfates, alkoxylated alcohol sulfonates, alkyl-aryl sulfonates, α-olefin sulfonates, alkane sulfonates, alkane sulfates, alkylphenol sulfates, alkylamide sulfates, alkylamine sulfates, alkylamide ether sulfates, alkylaryl polyether sulfonates, alkylphenol sulfonates, lignin sulfonates, petroleum sulfonates, phosphates esters, alkali metal, ammonium or amine salts of fatty acids (i.e., “soaps”), fatty alcohol ether sulfates, alkyl-ether carboxylates, N-acyl-N-alkyltaurates, arylalkane sulfonates, sulfosuccinate esters, alkyldiphenylethersulfonates, alkylnaphthalenesulfonates, naphthalenesulfonic acid-formaldehyde condensates, alkyl isothionates, fatty acid polypeptide condensation products, sulfonated glyceride oils, fatty acid monoethanolamide sulfates, a-sulfonated fatty acid esters, N-acyl glutamates, N-acyl glycinates, N-acyl alanates, acylated amino acids, and fluorinated anionics. Nonionic surfactants can include, but are not limited to, alkoxylated alkylphenols, alkoxylated alcohols, alkoxylated glycols, alkoxylated mercaptans, long-chain carboxylic acid esters, alkanolamine condensates, alkanolamides, tertiary acetylenic glycols, alkoxylated silicones, N-alkylpyrrolidones, pheno1,4,4′-(1-methylethylidene)bis-, polymer with methyloxirane (CAS number 29694-85-7; commercially available as GS-X-245 from Gulf Scientific, Inc., for example), alkylene oxide copolymers including ethylene oxide/propylene oxide copolymers, for example, Tergitol-L surfactants from Dow Chemicals, ethoxylated hydrocarbons, fatty amine oxides, fatty acid glycol partial esters, fatty acid alkanolamides, and alkylpolyglucosides. Zwitterionic and amphoteric surfactants can include, but are not limited to, C₈-C₁₈ betaines, C₈-C₁₈ sulfobetaines, C₈-C₂₄ alkylamido C₁-C₄ alkylenebetaines, 3-N-alkylaminopropionic acids, N-alkyl-3-iminodipropionic acids, imidazoline carboxylates, N-alkylbetaines, amidoamines, amidobetaines, amine oxides, and sulfobetaines. Cationic surfactants can include, but are not limited to, long-chain amines and corresponding salts, acylated polyamines, quaternary ammonium salts, imidazolium salts, alkoxylated long-chain amines, quaternized long-chain amines, and amine oxides. When present, the surfactant may be included in the imbibition composition in an amount from about 0.01 wt. % to about 4 wt. %, based on the total weight of the imbibition composition.

In yet another embodiment, the imbibition composition may further comprise a solvent. Examples of solvents include, but are not limited to, ethyl alcohol, n-propyl alcohol, isopropyl alcohol, isobutyl alcohol, n-butyl alcohol, sec-butyl alcohol, n-pentyl alcohol, sec-amyl alcohol, n-hexyl alcohol, n-octyl alcohol, 2-ethylhexyl alcohol, ethylene glycol n-butyl ether, diethylene glycol n-butyl ether, triethylene glycol n-butyl ether, propylene glycol methyl ether, propylene glycol methyl ether acetate, lauryl alcohol ethoxylates, glycerin, poly(glycerin), polyalkylene alcohol ethers, polyalkylene glycols, poly(oxyalkylene) glycols, poly(oxyalkylene) glycol ethers, and the like, and mixtures thereof. Recovered solvents can also be used. When present, the solvent may be included in the imbibition composition in an amount from about 0.01 wt. % to about 3 wt. %, based on the total weight of the imbibition composition.

In still another embodiment, the imbibition composition may further comprise an oilfield chemical additive. According to one particular embodiment, the oilfield chemical additive comprises a friction-reducing agent. When present, the oilfield chemical additive may be included in the imbibition composition in an amount from about 0.001 wt. % to about 25 wt. %, based on the total weight of the imbibition composition.

In some embodiments, the imbibition composition can be provided in dilute form or as a concentrate for dilution prior to use. Thus, in one embodiment, the imbibition composition is a concentrate comprising: i) from about 1 wt. % to about 99 wt. %, alternatively from about 5 wt. % to about 95 wt. %, alternatively from about 10 wt. % to about 90 wt. %, alternatively from about 15 wt. % to about 85 wt. %, or alternatively from about 20 wt. % to about 80 wt. % of the aqueous liquid; ii) from about 1 wt. % to about 99 wt. %, alternatively from about 5 wt. % to about 95 wt. %, alternatively from about 10 wt. % to about 90 wt. %, alternatively from about 15 wt. % to about 85 wt. %, or alternatively from about 20 wt. % to about 80 wt. % of the hydrophobically-modified dendrimer; iii) from about 0 wt. % to about 50 wt. %, alternatively from about 0.01 wt % to about 50 wt. % of the surfactant; and, iv) from about 0 wt. % to about 50 wt. %, alternatively from about 0.01 wt. % to about 50 wt. %, alternatively from about 0.1 wt. % to about 30 wt. % of the oilfield chemical additive, based on the total weight of the concentrate. Dilution of the aqueous concentrate with water to the desired level, in some embodiments from about 0.01 wt. % to about 5 wt. %, alternatively from about 0.05 wt. % to about 4 wt. %, alternatively from about 0.1 wt. % to about 2 wt. % of the hydrophobically-modified dendrimer, based on the io total weight of the imbibition composition, provides an injectable imbibition composition useful for crude oil recovery applications.

In one embodiment of a method, a hydrophobically-modified poly(aminoamide) (PAMAM) or poly(ethyleneimine) (PEI) dendrimer, is added to a fracturing fluid to form the imbibition composition and the imbibition composition is pumped into a formation at sufficient pressure. In preferred embodiments the fracturing fluid is an aqueous-based fracturing fluid, and more preferably a slick water fracturing fluid. An oilfield chemical additive may also be included in the fracturing fluid, or it may be added to the formation afterwards.

According to one embodiment, a method is provided for enhancing the zo imbibition of a water phase into a formation matrix, the method comprising:

a) introducing an imbibition composition into a permeable channel, the permeable channel defined by a surface that interfaces with and traverses the formation matrix, the permeable channel containing the water phase, and where the imbibition composition comprises: a fracturing fluid, a hydrophobically-modified dendrimer and optionally an oilfield chemical additive, and where the hydrophobically-modified dendrimer is operable to reduce water-oil interfacial tension and alter the wettability of a surface of the formation matrix from oil-wet or mixed-wet towards water-wet and is also operable to release the optional oilfield chemical additive into the water phase in the presence of the water phase and the optional oilfield chemical additive is operable to diffuse through the water phase, and where the formation matrix is an oil-wet or mixed-wet formation matrix; and

b) maintaining the imbibition composition in the permeable channel to allow the optional oilfield chemical additive to be controllably released from the hydrophobically-modified dendrimer, whereupon release from the dendrimer the optional oilfield chemical additive diffuses through the water phase to the surface of the oil-wet or mixed-wet formation matrix, and where the hydrophobically-modified dendrimer adsorbs into the surface of the oil-wet or mixed-wet formation matrix such that the wettability of the surface of the formation matrix is altered from oil-wet or mixed-wet to water-wet, and where altering the wettability of the surface of the formation matrix causes imbibition of the water phase into the formation matrix.

According to another aspect, there is provided a method for increasing recovery of crude oil from a subterranean hydrocarbon-bearing formation. The method comprises injecting the imbibition composition described above into a well which is in contact with the subterranean hydrocarbon-bearing formation. The imbibition composition can be used in an amount effective for lowering the interfacial tension between the fracturing fluid and crude oil trapped within the formation and can change the wettability of the subterranean hydrocarbon-containing formation, such as from oil-wet to water-wet, or from mixed-wet to water-wet, to recover the crude oil from the subterranean hydrocarbon-containing formation.

In still another aspect, there is provided a method for increasing recovery of crude oil from a hydrocarbon-bearing formation by inducing imbibition of a water phase into a formation matrix. The method comprises:

a) introducing through an injection well in the hydrocarbon-bearing formation, an imbibition composition into a permeable channel, the permeable channel defined by a surface that interfaces with and traverses the formation matrix, the permeable channel containing the water phase, and where the imbibition composition comprises: a fracturing fluid, a hydrophobically-modified dendrimer and an oilfield chemical additive, and where the hydrophobically-modified dendrimer is operable to reduce interfacial tension between the fracturing fluid and the oil and alter the wettability of a surface of the formation matrix from oil-wet or mixed-wet towards water-wet and is also operable to release the oilfield chemical additive into the water phase in the presence of the water phase and the oilfield chemical additive is operable to diffuse through the water phase, and where the formation matrix is an oil-wet or mixed-wet formation matrix;

b) maintaining the imbibition composition in the permeable channel to allow the oilfield chemical additive to be controllably released from the hydrophobically-modified dendrimer, whereupon release from the dendrimer the oilfield chemical additive diffuses through the water phase to the surface of the oil-wet or mixed-wet formation matrix, and where the hydrophobically-modified dendrimer adsorbs into the surface of the oil-wet or mixed-wet formation matrix such that the wettability of the surface of the formation matrix is altered from oil-wet or mixed-wet to water-wet, and where altering the wettability of the surface of the formation matrix causes imbibition of the water phase into the formation matrix, and where the imbibition causes the release of crude oil from the formation matrix; and

c) producing through a production well a production fluid, where the production fluid comprises the crude oil.

According to another embodiment the present disclosure provides a proppant for hydraulically fracturing a subterranean hydrocarbon-bearing formation. The proppant is typically used in conjunction with a fracturing fluid to hydraulically fracture the subterranean formation which defines a subsurface reservoir (for e.g. a wellbore or reservoir itself). Here, the proppant is operable to prop open the fractures in the subterranean formation after the hydraulic fracturing.

In one embodiment, the proppant comprises a particulate and a coating disposed on the particulate. The coating is described additionally below. Although the particulate may be of any size, the particulate typically can have a particle size distribution of from about 10 mesh to about 100 mesh, more typically from about 20 mesh to about 70 mesh, as measured in accordance with standard sizing techniques using the United States Sieve Series. That is, the particulate typically can have a particle size of from about 149 μm to about 2,000 μm, more typically of from about 210 μm to about 841 μm. Particulates having such particle sizes can allow less coating to be used, can allow the coating to be applied to the particulate at a lower viscosity, and can allow the coating to be disposed on the particle with increased uniformity and completeness as compared to particulates having other particle sizes.

Although the shape of the particulate is not critical, particulates having a spherical shape typically can impart a smaller increase in viscosity in a hydraulic fracturing composition than particulates having other shapes, the hydraulic fracturing composition comprising a mixture of the fracturing fluid and the proppant. Typically, the particulate can have either a round or roughly spherical shape.

Examples of particulates which can be used in the present disclosure include any known particulate for use during hydraulic fracturing. Non-limiting examples include minerals, ceramics such as sintered ceramic particles, sands, nut shells, gravel, mine tailings, coal ashes, rocks, smelter slag, diatomaceous earth, crushed charcoals, micas, sawdust, wood chips, resinous particles, polymeric particles, metallic particles and combinations thereof. It is to be appreciated that other particulates not recited herein may also be suitable for the purposes of the present disclosure.

According to one aspect, sand is a preferred particulate and when applied in this technology is commonly referred to as frac or fracturing sand. Examples of sand include, but are not limited to, Arizona sand, Wisconsin Sand, Brady sand, and Ottawa sand.

Specific examples of sintered ceramic particles include, but are not limited to, aluminum oxide, silica, bauxite, and combinations thereof. The sintered ceramic particle may also include clay-like binders.

Particulates useful for purposes of the present disclosure may even be formed from resins and polymers. Specific examples of resins and polymers for the particulate include, but are not limited to, polyurethanes, polycarbodiimides, polyureas, acrylics, polyvinylpyrrolidones, acrrylonitrile-butadiene styrenes, polystyrenes, polyvinyl chlorides, fluoroplastics, polysulfides, nylon and combinations thereof.

Examples of metallic particles include, but are not limited to, aluminum shot, aluminum pellets, aluminum needles, aluminum wire, iron shot, steel shot, and the like, as well as any resin coated versions of these metallic particles.

As indicated above, the proppant also includes the coating. As set forth above, the coating is disposed on the particulate. As used herein, “disposed on” encompasses “disposed about” the particulate and also covers both partial and complete covering of the particulate by the coating.

According to one embodiment the coating comprises a dendrimer. In another embodiment the dendrimer comprises at least one of a poly(aminoamide) dendrimer, a poly(ethyleneimine) dendrimer, a poly(propyleneimine) dendrimer, a hydrophobically-modified dendrimer or a mixture thereof. According to another embodiment the dendrimer is selected from a poly(aminoamide) dendrimer, a poly(ethyleneimine) dendrimer and a mixture thereof. In another embodiment the dendrimer is a hydrophobically-modified dendrimer.

The amount of the dendrimer disposed onto the particulates, either alone or in combination with other components, depends upon the specific application of the proppant, but is typically disposed on the particulate in an amount from about 0.001 wt. % to about 20 wt. %, based on 100 parts by weight of the proppant. In other embodiments, the coated particulate contains from about 0.01 wt. % to about 10 wt. %, alternatively from about 0.1 wt. % to about 8 wt. % of the dendrimer, based on 100 parts by weight of the coated proppant. In other embodiments, and in accordance with the present disclosure, the coated particulate contains at least about 0.001 wt. %, at least about 0.01 wt. %, at least about 0.1 wt. %, at least about 0.5 wt. %, at least about 0.6 wt. %, at least about 0.7 wt. %, at least about 0.8 wt. %, at least about 0.9 wt. %, at least about 1.0 wt. %, at least about 2.0 wt. %, at least about 3.0 wt. %, at least about 4.0 wt. %, at least about 5.0 wt. %, at least about 6.0 wt. %, at least about 7.0 wt. %, at least about 8.0 wt. %, or at least about 9.0 wt. %, to about 10.0 wt. %, as well as in any amount falling within the range defined by these values, for e.g., from about 0.5 wt. % to about 6.0 wt. %, of the dendrimer, all based on 100 parts by weight of the proppant.

The coating may further comprise an oilfield chemical additive. According to several exemplary embodiments, the oilfield chemical additive is present on the coated particulate in any suitable amount. According to some embodiments, the coated particulate contains at least about 0.01 wt. %, at least about 0.1 wt. %, at least about 0.5 wt. %, at least about 1 wt. %, at least about 2 wt. %, at least about 4 wt. %, at least about 6 wt. %, or at least about 10 wt. % of the oilfield chemical additive, based on 100 parts by weight of the coated proppant. According to other embodiments the coated proppant contains less than about 60 wt. %, less than about 50 wt. %, less than about 40 wt. %, less than about 30 wt. %, less than about 25 wt. %, less than about 20 wt. %, less than about 15 wt. % or less about 10 wt. % of the oilfield chemical additive, based on 100 parts by weight of the coated proppant. In still yet another embodiment the coated proppant contains from about 0.05 wt. % to about 50 wt. %, or from about 0.5 wt. % to about 30 wt. %, or from about 1 wt. % to about 20 wt. %, or from about 2 wt. % to about 10 wt. %, of the oilfield chemical additive, based on 100 parts by weight of the coated proppant.

As described herein, the coating may also be further defined as a controlled release coating comprising the dendrimer. That is, the coating may systematically dissolve and/or hydrolyze in a controlled manner to expose the particulate to the petroleum fuels in the subsurface reservoir. The coating typically gradually dissolves in a consistent manner over a pre-determined time period to decrease the thickness of the coating. This embodiment is especially useful for applications utilizing the oilfield chemical additive and is operable to allow the oilfield chemical additive to release from the proppant in a controlled manner.

Various techniques can be used to coat the particulate. These techniques include, but are not limited to, mixing, pan coating, fluidized-bed coating, co-extrusion, spraying, in-situ formation of the coating, and spinning disk encapsulation. The technique for applying the coating to the particle is selected according to cost, production efficiencies, and batch size.

In one particular embodiment, the coating is disposed on the particulate via spraying or mixing. In another particular embodiment, the coating is disposed on the particulate by mixing the particulate and optional oilfield chemical additive with the particulate. In still another embodiment, the individual components of the coating are contacted in a spray device to form a coating mixture. The coating mixture is then sprayed onto the particulates to form the proppant. Spraying the coating onto the particulates results in a uniform, complete, and defect-free coating disposed on the particulate. For example, the coating is typically even and unbroken. The coating also typically has adequate thickness and acceptable integrity, which allows for applications requiring controlled-release of the proppant in the fracture. Spraying also typically results in a thinner and more consistent coating disposed on the particulate as compared to other techniques, and thus the proppant is coated economically. Spraying the particulate even permits a continuous manufacturing process. Spray temperature is typically selected by one known in the art according to coating technology and ambient humidity conditions. Further, one skilled in the art typically sprays the components at a viscosity commensurate with the viscosity of the components.

According to some embodiments, the dendrimer and optional oilfield chemical additive are dissolved or dispersed in a liquid medium at a concentration of between about 0.5 wt. % to about 10 wt. %, preferably from about 1.0 wt. % to about 5.0 wt. %, based on the total weight of the liquid medium. The liquid medium is then applied to the particulates at an amount of between about 10 L/Tonne and about 0.1 L/Tonne of proppant. In preferred embodiments this amount is between about 5 L/Tonne and about 0.5 L/Tonne proppant.

In some aspects, the proppants may be used in concentrations from about 1 to about 18 pounds per gallon (about 120 g/L to about 2,160 g/L) of fracturing fluid, but higher or lower concentrations may also be used as required.

In another embodiment of a method according to the present disclosure, a particulate is coated with a dendrimer such as a poly(amidoamine) dendrimer, a poly(ethyleneimine) dendrimer and/or a hydrophobically-modified dendrimer and with the oilfield chemical additive. Applicant contemplates several embodiments of the method for coating particulates with the dendrimer and/or hydrophobically-modified dendrimer and the oilfield chemical additive.

In one embodiment, particulates are treated by contacting, for example by spraying them or mixing them, with a liquid medium containing the dendrimer and/or hydrophobically-modified dendrimer, and an oilfield chemical additive, for example, a scale inhibitor or a wax inhibitor. The coated proppants may then be dried and stored for later use or used directly. The preferred liquid medium is aqueous, alcohol or water containing certain amounts of alcohol.

Alternatively, particulates may be treated by contacting them, for example by spraying or mixing, with a liquid medium containing the dendrimer and/or hydrophobically-modified dendrimer, an oil and the oilfield chemical additive, for example a scale inhibitor. The coated proppants may then be dried and stored for later use or used directly. The preferred liquid medium is alcohol or alcohol containing certain amount of water.

In another embodiment, for a hydraulic fracturing operation, a preferred method of coating particulates with a liquid medium comprising the dendrimer and/or hydrophobically-modified dendrimer and oilfield chemical additive is to apply the liquid medium, preferably by spraying, onto the particulates “on-the-fly”. “On-the-fly” means that a flowing stream is continuously introduced into another flowing stream so that the streams are combined and mixed while continuing to flow as a single stream. In the instant disclosure, on-the-fly refers to the application of the liquid medium comprising the compounds above to the surface of the particulates when the particulates are being used in a hydraulic fracturing operation, and before the particulates are added to the hydraulic fracturing fluid. An apparatus for treating the particulates on-the-fly has been described in Canadian Patent Application No. 2,877,025 which is incorporated herein by reference in its entirety.

Alternatively, the particulates can be pre-treated with the dendrimer and/or hydrophobically-modified dendrimer before the oilfield chemical additive is applied to the surface of the particulates. That is, the particulates may be first treated by contacting them with a liquid medium containing the dendrimer and/or hydrophobically-modified dendrimer (for e.g., by spraying or mixing them with the liquid medium) to form pre-treated particulates. These pre-treated particulates may then be dried and stored to be treated later with the oilfield chemical additive, or they may be treated with the oilfield chemical additive directly afterwards. The oilfield chemical additive may be applied to the surface of the pre-treated particulates, for example, by contacting the pre-treated particulates with a liquid medium that contains the oilfield chemical additive (for e.g., by spraying them or mixing them with the liquid medium) to form the coated particulates. The coated particulates may then be dried and stored for later use or used directly. The preferred liquid medium is alcohol or alcohol containing an amount of water.

In a hydraulic fracturing operation, the oilfield chemical additive, for example, a wax inhibitor, or a biocide, may be sprayed onto the pre-treated particulates on-the-fly, before the coated particulates are added into the fracturing fluid. Alternatively again, an oil, such as a mineral oil, can be added to the liquid medium used to treat the particulates with the dendrimer and/or hydrophobically-modified dendrimer and/or oilfield chemical additive.

Contemplated herein are embodiments in which more than one oilfield chemical additive can be used. For example, a wax inhibitor, an inorganic scale inhibitor and a biocide may be used. Applicant also contemplates herein the use of more than one dendrimer and/or hydrophobically-modified dendrimer, to coat the particulates.

According to one embodiment, the proppant is prepared according to the methods as set forth above and stored in an offsite location before being pumped into the subterranean formation and the subsurface reservoir. As such, coating typically can occur offsite from the subterranean formation and subsurface reservoir. However, as described above, it is to be appreciated that the proppant may also be prepared just prior to being pumped into the subterranean formation and the subsurface reservoir. In this scenario, the proppant may be prepared with a portable coating apparatus at an onsite location of the subterranean formation and subsurface reservoir. The proppant is useful for hydraulic fracturing of the subterranean formation to enhance recovery of crude oil and the like. In a typical hydraulic fracturing operation, a hydraulic fracturing composition, i.e., a mixture comprising the fracturing fluid, the proppant, and optionally various other components, is prepared. The fracturing fluid is selected according to wellbore conditions and is mixed with the proppant to form the mixture which is the hydraulic fracturing composition. The mixture is pumped into the subsurface reservoir, which may be the wellbore, to cause the subterranean formation to fracture. More specifically, hydraulic pressure is applied to introduce the hydraulic fracturing composition under pressure into the subsurface reservoir to create or enlarge fractures in the subterranean formation. When the hydraulic pressure is released, the proppant holds the fractures open, thereby enhancing the ability of the fractures to extract crude oil or other fluids from the subsurface reservoir to the wellbore. The crude oil is typically extracted from the subsurface reservoir via the fracture, or fractures, in the subterranean formation through methods known in the art of oil extraction. The crude oil is typically provided to oil refineries as feedstock, and the proppant typically remains in the fracture. Alternatively, in a fracture that is nearing its end-of-life, for e.g. a fracture that contains crude oil that cannot be economically extracted by current oil extraction methods, the proppant may also be used to extract natural gas as the fluid from the fracture. The proppant, particularly where an oilfield chemical additive is utilized, digests hydrocarbons by contacting the oilfield chemical additive with the fluid to convert the hydrocarbons in the fluid into propane or methane. The propane or methane is then typically harvested from the fracture in the subsurface reservoir through methods known in the art of natural gas extraction.

While the method and composition are described in conjunction with the disclosed embodiments and examples which are set forth in detail, it should be understood that this is by illustration only. The scope of the claims should not be limited to the preferred embodiments but should be given the broadest interpretation consistent with the description as a whole.

### EXAMPLES

### Example 1

### Controlled Release of Scale Inhibitor

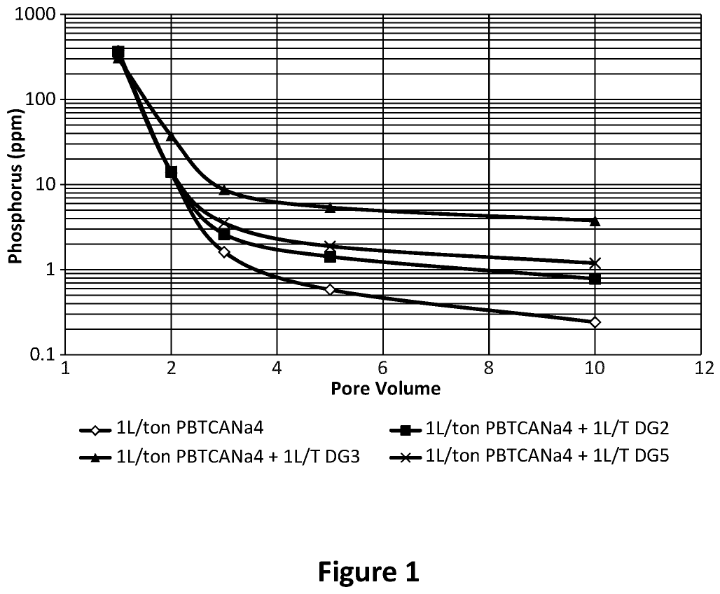

0.15 mL of an asymmetric amino-terminated poly(aminoamide) (PAMAM) of different Generations (DG 2, DG 3 and DG 5) was sprayed, respectively, on 150 grams of 20/40 US mesh frac sand. This was followed by application of 0.15 mL of a 40% aqueous solution of 2-phosphonobutane-1,2,4-tricarboxylic acid sodium salt (PBTCANa4; a scale inhibitor). After being completely dried in the air, the sand was packed in a glass column and water was poured into the column and dripped out at 1 drop per second. The effluent was collected and its phosphorus concentration was measured using Inductively Coupled Plasma Optical Emission Spectroscopy (ICP-OES) as the measure of release of PBTCANa4. As a control, the test was repeated using 20/40 US mesh frac sand that was not coated with PAMAM, but that was coated with PBTCANa4, as above. The results are shown in FIG. 1. In the first pore volume of water, the phosphorous concentration in the effluent was 371.3 (control), 363.8 (DG 2), 305.9 (DG 3) and 341.5 (DG 5) ppm.

### Example 2

### Interfacial Tension Test and Amott Oil Recovery Test

1 L/m³ of concentrate samples of different activities (see Table 1) in 3% KCl water were prepared and used for interfacial tension and Amott cell measurements. Interfacial tension (IFT) of various asymmetric dendrimer and hydrophobically-modified dendrimer samples were measured using a KRUSS Spinning Drop Tensiometer. Oil-saturated cores were immersed in the solution (300 mL) in the Amott cell. The Eagleford formation cores were saturated with Strath condensate (45° API) for one week under pressure (1000 psig N2). Oil recovery was measured over 5 days. The results are shown below in Table 1:

TABLE 1

| | | | | | Oil |
|---|---|---|---|---|---|
| | | Dendritic | Hydrophobic | IFT | Recovered |
| Sample | Activity | core | modification | (mN/m) | (%) |
| Water (3% KCl) | — | — | — | 3.24 | 9.52 |
| Generation 1 | 20 | PAMAM | None | 3.42 | |
| Generation 2 | 20 | PAMAM | None | 3.56 | 5.68 |
| Generation 2 | 80 | PEI | None | 1.29 | 13.89 |
| Generation 4 | 20 | PAMAM | None | 2.50 | |
| hydroxy-terminated | | | | | |
| Generation 5 | 20 | PAMAM | None | 2.30 | |
| Generation 5 | 50 | PEI | None | 1.48 | |
| Generation 3 ethoxylated | 80 | PEI | None | 1.64 | 11.36 |
| Generation 2 | 70 | PEI | alkylaryl | 0.08 | 21.05 |
| (25% modification) | | | sulfonate¹ | | |
| Generation 2 | 20 | PAMAM | C12 alkyl chain | 0.02 | 33.33 |
| (25% modification) | | | | | |
| Generation 2 | 70 | PEI | alkylaryl | 0.06 | 26.32 |
| (50% modification) | | | sulfonate¹ | | |

¹alkalyl sulfonate: CH₃(CH₂)₁₁C₆H₄SO₂

### Example 3

### Mixture of a Dendrimer and a Surfactant

The interfacial tension of a water solution of dendrimer G-2 poly(ethyleneimine) (PEI) and an anionic sodium dodecylsulfate (SDS) were measured and the results are listed in Table 2:

TABLE 2

| | Components | | |
|---|---|---|---|
| | SDS | PEI² | IFT³ |
| Blend | (kg/m3) | (L/m3) | (mN/m) |
| Blank¹ | — | — | 3.55 |
| A | 2.0 | — | 0.31 |
| B | — | 2.0 | 1.03 |
| C | 1.0 | 1.0 | 0.05 |

¹Tap water.
²Activity is 80%
³Strath condensate (45° API) is used for oil phase for IFT measurement.

As shown above, it can be seen that there is synergy between PEI and SDS manifested by a much lower IFT of the mixture.

1. A proppant for hydraulically fracturing a subterranean hydrocarbon-bearing formation, the proppant comprising:
a) a particulate; and
b) a coating disposed on the particulate, the coating comprising a dendrimer comprising a poly(aminoamide) dendrimer, a poly(ethyleneimine) dendrimer, a poly(propyleneimine) dendrimer, a hydrophobically-modified dendrimer or a mixture thereof and optionally an oilfield chemical additive.

2. The proppant of claim 1, wherein the particulate comprises a mineral, ceramic, sand, nut shell, gravel, mine tailing, coal ash, rock, smelter slag, diatomaceous earth, crushed charcoal, mica, sawdust, wood chip, resinous particle, polymeric particle, metallic particle or a mixture thereof.

3. (canceled)

4. (canceled)

5. The proppant of claim 1, wherein the dendrimer comprises a poly(aminoamide) dendrimer or a poly(ethyleneimine) dendrimer.

6. The proppant of claim 3, wherein the dendrimer comprises a hydrophobically-modified dendrimer.

7. The proppant of claim 1, wherein the hydrophobically-modified dendrimer is a hydrophobically-modified asymmetric poly(ethyleneimine) dendrimer.

8. The proppant of claim 1, wherein the dendrimer is disposed on the particulate in an amount from about 0.001 wt. % to about 20 wt. %, based on 100 parts by weight of the proppant.

9. (canceled)

10. (canceled)

11. A method of forming the proppant of claim 1 comprising disposing the coating on the particulate by mixing the coating with the particulate or spraying the coating on the particulate wherein the coating further comprises a liquid medium comprising an alcohol and optionally water.

12. The method of claim 11, wherein the coating is disposed on the particulate by spraying the coating on the particulate on-the-fly.

13. The method of claim 11, wherein the coating is sprayed on the particulate to form a pre-treated particulate and an oilfield chemical additive is subsequently applied to a surface of the pre-treated particulate to form the proppant.

14. A hydraulic fracturing composition comprising a fracturing fluid and the proppant of claim 1.

15. A method of hydraulically fracturing a subterranean formation which defines a subsurface reservoir comprising pumping the hydraulic fracturing composition of claim 14 into the subsurface reservoir to cause the subterranean formation to fracture.

16. An imbibition composition for increasing recovery of crude oil from a subterranean hydrocarbon-bearing formation, the imbibition composition comprising a fracturing fluid, a hydrophobically-modified dendrimer comprising one or more active hydrogens on a surface of the dendrimer and optionally an oilfield chemical additive.

17. The imbibition composition of claim 16, wherein the fracturing fluid comprises an aqueous liquid.

18. The imbibition composition of claim 17, wherein the aqueous liquid comprises a slick water fracturing fluid.

19. (canceled)

20. The imbibition composition of claim 16, wherein the hydrophobically-modified dendrimer comprises a hydrophobically-modified symmetric dendrimer.

21. The imbibition composition of claim 16, wherein the hydrophobically-modified dendrimer comprises a hydrophobically-modified asymmetric dendrimer.

22. The imbibition composition of claim 16, wherein the hydrophobically-modified dendrimer comprises a hydrophobically-modified asymmetric poly(ethyleneimine) dendrimer.

23. The imbibition composition of claim 16, wherein the dendrimer is hydrophobically-modified by substitution of the one or more active hydrogens with an aliphatic or aromatic, saturated or unsaturated, linear, branched or cyclic hydrophobic group comprising from 4 carbon atoms to 40 carbon atoms, each of the carbon atoms optionally substituted with a hydroxy group, a C₁ to C₁₀ alkyl group, a C₁ to C₁₀ alkoxy group, a phenyl group, a phenyl group substituted with from 1 to 5 groups of a C₁ to C₅ alkyl group, a C₁ to C₅ alkoxy group, a phenoxy group or a phenoxy group substituted with from 1 to 5 groups of a C₁ to C₅ alkyl group or a C₁ to C₅ alkoxy group.

24. The imbibition composition of claim 16, wherein the dendrimer is hydrophobically-modified by substitution of the one or more active hydrogens with a C₈ to C₂₂ alkyl group, an arylalkyl group or an alkylaryl group optionally substituted with a hydroxy group, an alkoxy group or a sulfonate group.

25. The imbibition composition of claim 24, wherein from about 0.1% to about 99% of the active hydrogens on the surface of the dendrimer are substituted with the C₈ to C₂₂ alkyl group, the arylalkyl group or the alkylaryl group optionally substituted with the hydroxy group, the alkoxy group or the sulfonate group.

26. The imbibition composition of claim 16, further comprising a surfactant.

27. (canceled)

28. A method for controlling the release of an oilfield chemical additive in a subterranean formation comprising contacting the oilfield chemical additive with a dendrimer comprising a poly(aminoamide) dendrimer, a poly(ethyleneimine) dendrimer, a poly(propyleneimine) dendrimer, a hydrophobically-modified dendrimer or a mixture thereof either prior to placing the oilfield chemical additive in the subterranean formation or after the oilfield chemical has been placed within the subterranean formation.

29. A method for increasing recovery of crude oil from a subterranean hydrocarbon-bearing formation comprising injecting the imbibition composition of claim 16 into a well which is in contact with the subterranean hydrocarbon-bearing formation.

30. The method of claim 29, wherein the hydrophobically-modified dendrimer comprises a hydrophobically-modified asymmetric dendrimer.

31. The method of claim 30, wherein the hydrophobically-modified asymmetric dendrimer comprises a hydrophobically-modified asymmetric poly(ethyleneimine) dendrimer.

32. A method for enhancing the imbibition of a water phase into a formation matrix, the method comprising:
a) introducing an imbibition composition into a permeable channel, the permeable channel defined by a surface that interfaces with and traverses the formation matrix, the permeable channel containing the water phase, and wherein the imbibition composition comprises: a fracturing fluid, a hydrophobically-modified dendrimer comprising a hydrophobically-modified asymmetric dendrimer and optionally an oilfield chemical additive, and where the hydrophobically-modified dendrimer is operable to alter the wettability of a surface of the formation matrix from oil-wet towards water-wet and is also operable to release the optional oilfield chemical additive into the water phase in the presence of the water phase and the optional oilfield chemical additive is operable to diffuse through the water phase, and wherein the formation matrix is an oil-wet formation matrix; and
b) maintaining the imbibition composition in the permeable channel to allow the optional oilfield chemical additive to be controllably released from the hydrophobically-modified dendrimer, whereupon release from the dendrimer the optional oilfield chemical additive diffuses through the water phase to the surface of the oil-wet formation matrix, and wherein the hydrophobically-modified dendrimer adsorbs into the surface of the oil-wet formation matrix such that the wettability of the surface of the formation matrix is altered from oil-wet to water-wet, and wherein altering the wettability of the surface of the formation matrix causes imbibition of the water phase into the formation matrix.

33. (canceled)

34. The method of claim 31, wherein the hydrophobically-modified asymmetric dendrimer comprises a hydrophobically-modified asymmetric poly(ethyleneimine) dendrimer.

35. A method for increasing recovery of crude oil from a hydrocarbon-bearing formation by inducing imbibition of a water phase into a formation matrix, the method comprising:
a) introducing through an injection well in the hydrocarbon-bearing formation, an imbibition composition into a permeable channel, the permeable channel defined by a surface that interfaces with and traverses the formation matrix, the permeable channel containing the water phase, and wherein the imbibition composition comprises: a fracturing fluid, a hydrophobically-modified dendrimer comprising a hydrophobically-modified asymmetric dendrimer and an optional oilfield chemical additive, and wherein the hydrophobically-modified dendrimer is operable to alter the wettability of a surface of the formation matrix from oil-wet towards water-wet and is also operable to release the oilfield chemical additive into the water phase in the presence of the water phase and the oilfield chemical additive is operable to diffuse through the water phase, and wherein the formation matrix is an oil-wet formation matrix;
b) maintaining the imbibition composition in the permeable channel to allow the optional oilfield chemical additive to be controllably released from the hydrophobically-modified dendrimer, whereupon release from the dendrimer the optional oilfield chemical additive diffuses through the water phase to the surface of the oil-wet formation matrix, and wherein the hydrophobically-modified dendrimer adsorbs into the surface of the oil-wet formation matrix such that the wettability of the surface of the formation matrix is altered from oil-wet to water-wet, and wherein altering the wettability of the surface of the formation matrix causes imbibition of the water phase into the formation matrix, and wherein the imbibition causes the release of crude oil from the formation matrix; and
c) producing through a production well a production fluid wherein the production fluid comprises the crude oil.

36. (canceled)

37. The method of claim 37, wherein the hydrophobically-modified asymmetric dendrimer comprises a hydrophobically-modified asymmetric poly(ethyleneimine) dendrimer.

38. A method for reducing fugitive dust from particulates comprising coating the particulates with a dendrimer comprising a poly(aminoamide) dendrimer, a poly(ethyleneimine) dendrimer, a poly(propyleneimine) dendrimer, a hydrophobically-modified dendrimer or a mixture thereof thereby reducing dust production therefrom as compared to uncoated particulates.
